(19) United States
(12) Patent Application Publication
(10) Pub. No.: US 2024/0097607 A1
(43) Pub. Date: Mar. 21, 2024

(54) PLANT FOR THE PRODUCTION OF ELECTRICITY AND FOR THE TREATMENT OF AGRICULTURAL LAND

(71) Applicant: REM TEC S.R.L., Asola (MN) (IT)

(72) Inventors: Alessandro Reboldi, Rezzato (BS) (IT); Giancarlo Ghidesi, Asola (MN) (IT)

(21) Appl. No.: 18/275,851

(22) PCT Filed: Feb. 17, 2022
(86) PCT No.: PCT/IB2022/051418

§ 371 Date: Aug. 4, 2023

(30) Foreign Application Priority Data
Feb. 22, 2021 (IT) 102021000003980

(51) Int. Cl. H02S 20/32; H02S 10/12

(52) U.S. Cl. CPC H02S 20/32; H02S 10/12

(57) ABSTRACT

A plant for the production of electrical energy comprising a support structure formed by support poles (2) aligned along a first axis (X) fixed to the ground; said structure being configured with a plurality of parallel rows (Fi) of such poles (2) with any orientation, causing the formation of a two-dimensional structure along such axis (X) and a second axis (Y) substantially orthogonal to the first to form a “chessboard” structure, •this structure being installed on agricultural land (T), and the distance between the support posts, along both the X and Y axes, is such as to allow the passage and processing of the land by agricultural vehicles or vehicles, •on said support structure and in particular on rows of poles being positioned devices for the generation of electricity, characterized by the fact that the plant includes means for the power supply of such electric agricultural vehicles or vehicles that work the land (T) where the plant is installed that use part of the electricity produced by the plant itself.

The present invention relates to a solar and/or wind power generation plant comprising a raised support structure positioned on agricultural land to support devices capable of receiving sunlight, for example photovoltaic panels and/or wind modules. Preferably, but not exclusively, the system allows for the movement, by means of a special handling system, of such devices around two axes X and Y, in order to keep photovoltaic panels or other devices for capturing solar energy correctly oriented towards the sun.

Such a plant can be installed on agricultural land, leaving the possibility of using that land for its original purpose, i.e. for growing vegetables, grains or grazing animals.

The system consists of a support structure made up of poles and tie rods or profiles connecting said poles.

Agricultural installations can also be obtained underneath.

Such a plant is described in patent application WO2019049094 where greenhouses for growing vegetables are placed on the same land as the power plant. The electricity produced by the plant is also used to power devices to manage the crops (e.g. sprinklers, environmental sensors placed inside and outside the greenhouse).

Systems for moving solar panels on two axes are known, which are known in jargon as “solar trackers”.

The main purpose of a tracker is to maximise the efficiency of the on-board solar device. The greater the perpendicular alignment with the sun's rays, the greater the conversion efficiency and the more energy produced for the same surface area, the smaller the surface area of solar panel required for the same output, the lower the installation costs.

The orientation of the modules is also defined to prevent mutual shading which would drastically reduce production.

The orientation of the modules, and the shade they generate, can also be managed in favour of the underlying crops, in order to promote their development and growth.

The most sophisticated trackers have two degrees of freedom, with which they aim to perfectly align the orthogonal of the photovoltaic panels with the sun's rays in real time. The cheapest, but not the only, way to do this is to mount one tracker on board another. With these trackers, increases in electricity production of up to 35%-45% can be achieved, but with greater construction complexity.

Such a type of solar tracker is shown in patent application WO2010103378 which describes a support structure consisting of support posts held in position by a grid of tie rods, both the support posts and the tie rods being fixed in the ground by a hinge pin.

The solar tracker comprises a main horizontal load-bearing profile, which can rotate about its own axis, to which a plurality of secondary profiles are connected, fixed perpendicularly to the main profile and which can be rotated about their own axis. The solar panels are attached to these secondary profiles.

The ends of the main tracker profile are supported and fixed onto support profiles.

Patent WO2013076573 describes such a support piling structure that also supports wind modules. This structure is made two-dimensional in a “chess board” manner and can be installed on agricultural land because it is raised and the distance between the support poles is such as to allow the passage of even large agricultural vehicles.

Patent application WO2013117722 describes a method and plant for producing solar energy that is suitable for installation on agricultural land. In such a plant, the photovoltaic modules and the support structure can be oriented in such a way that a cultivated area underneath the modules is partially shaded. In this case, the orientation of the photovoltaic modules according to the invention allows for incident solar radiation on the cultivated plants.

It is also well known that recently agricultural tractors or, in general, electrically powered agricultural vehicles have come onto the market. For example, in European patent EP3601015, a multifunctional electric tractor is proposed having a base structure, wheels and at least one central motor, first tool means capable of performing work in a work area A located on a first side of the base structure, second tool means capable of performing work in a work area B located on the second side of the base structure. At least two of these wheels include an integrated motorization and both this integrated motorization and the central motorization consist of electric motors.

Road vehicles are also known called “trolleybuses” powered by overhead lines. The trolleybus is an electrically powered trolley vehicle designed in particular for passenger transport and powered by a double overhead line called a bifilar, suspended over the roadway, from which the vehicle picks up direct current electricity via two collector rods.

The recent development of accumulators has made it possible to build trolleybus models that allow a certain distance to be covered without connection to the two-wire network and/or supply track.

The applicant has noted that these support structures for solar panels leave a suitable space for the cultivation of plants and the passage of agricultural vehicles. In addition, the same structures, e.g. integrated with special supports, can be used for the installation of suspended power lines for supplying and/or recharging electric and/or hybrid vehicles used for agricultural work. In fact, the support structures (the poles) of the solar and/or wind power plant can advantageously be used as support structures for such overhead lines.

In addition, a portion of the electrical energy generated by the plant can be used to supply these suspended power and/or charging lines, or to supply charging stations for these electric and/or hybrid vehicles in the absence of the suspended power lines.

An aspect of the present invention relates to a having the characteristics of the appended claim 1.

Further features of the present invention are contained in the dependent claims.

The characteristics and advantages of the present invention will become more apparent from the following description of an embodiment of the invention, provided by way of non-limiting example, with reference to the schematic attached drawings, wherein:

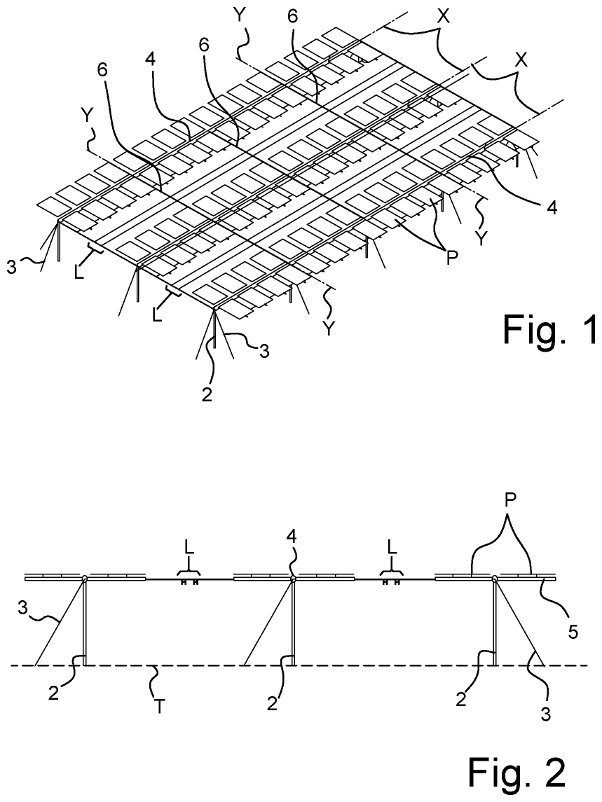

FIG. 1 shows an exemplary perspective view of a plant according to the present invention;

FIG. 2 shows a front view of the plant in FIG. 1;

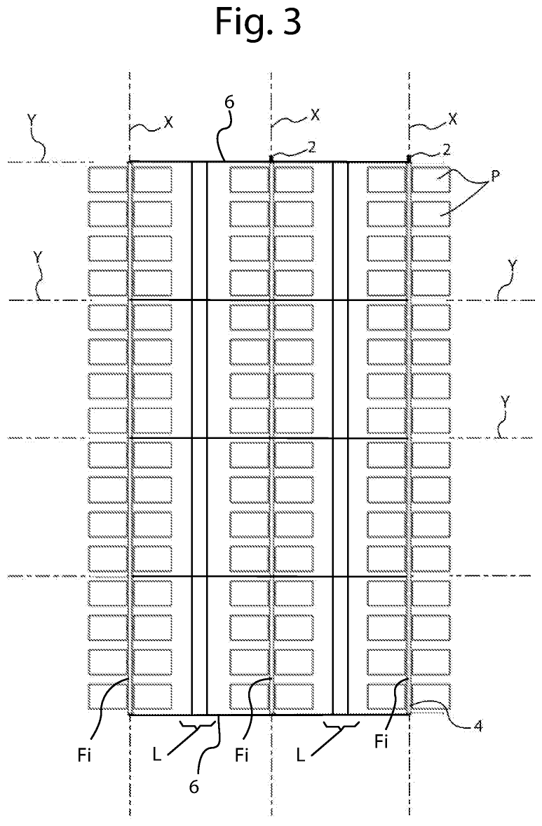

FIG. 3 shows a top view of the plant in FIG. 1.

With reference to the aforementioned figures, the plant for generating electricity according to the present invention essentially comprises a support structure formed by support poles 2 preferably held in position by a network of tie rods or pole connection profiles 3, both the support poles and the tie rods being fixed in the ground by means of suitable connections, for example hinge pins in the case of a tensile structure. Such a structure can advantageously be configured with a plurality of parallel rows Fi of poles with each row of poles aligned along a first axis X in any orientation. The parallel rows of poles result in the formation of a two-dimensional structure along this axis X and a second axis Y preferably but not exclusively orthogonal to the first to form a “chessboard” structure, which can be installed on agricultural land, as it is overhead and the distance between the support poles (along both the axes X and Y) is such as to even allow the passage of very large agricultural vehicles. In addition, agricultural installations can be obtained on this plant.

This support structure can alternatively be built by means of concrete piles, which will have one part driven into the ground and one part above ground to give the structure the appropriate height above ground. This piling may or may not be connected by tie rods or steel bars.

On said support structure and in particular on rows of piles devices are placed for the generation of electrical energy such as devices capable of receiving sunlight, e.g. photovoltaic panels.

Preferably, systems for the movement or orientation of these devices are arranged on said support structure. In addition to or instead of these solar devices, wind devices can also be placed on top of these poles.

The movement system allows movement on the first axis X and also on the second axis Y, of the devices designed to receive sunlight, to allow them to maintain the desired and correct orientation towards the sun.

Each movement system comprises a main profile rotating 4 about its own axis, and arranged in place substantially horizontally, to which a plurality of secondary profiles 5 are connected, preferably fixed perpendicularly to the main profile in a rigid manner or alternatively by means of suitable systems to confer the rotation capacity. Generation devices, in this case photovoltaic panels P, are fixed to these secondary profiles.

The movement system also includes a movement mechanism for primary profiles and optionally a movement mechanism for secondary profiles.

Clearly, the materials for the various parts were chosen appropriately for the right balance of weight and strength.

The movements of the motors that allow the aforementioned rotations about the axes X and Y are controlled by a special electronic processing unit that determines the angle that the panels must present throughout the day and in all weather conditions, with feedback through a special tilt sensor.

Since this system can move the panels in the first axis X and also in the second axis Y, the movement or orientation of solar devices is always possible regardless of the arrangement of the system on the ground.

According to the present invention, below this support structure there are agricultural crops, including crops on the soil T below the plant.

Through the movement of the receptor devices the electronic processing unit regulates the shadow generated on the ground according to the direct light requirements, in order to optimize the development or growth of these crops, also taking into account other parameters such as temperature and soil humidity.

According to the present invention, the system comprises means for electrically powering and/or electrically recharging agricultural vehicles that work the land T where the plant is installed, using part of the electrical energy produced by the plant itself.

Such vehicles may comprise a plurality of overhead power L lines for powering electric and/or hybrid agricultural vehicles or vehicles equipped with appropriate single or pantograph collector rods (similar to the common trolley bus rods).

Such power lines L are advantageously placed in the space between two rows of poles substantially parallel to such rows, or they may be placed orthogonally to such rows of poles, again in the space comprised between two adjacent poles. Advantageously, the lines are kept suspended by the support structure consisting of support poles 2 and the network of tie rods or connecting profiles of poles 3, supplemented if necessary by additional supports. For example, in the embodiment illustrated in the figures, transverse supports 6 are provided which support the supply lines L placed in a median position between two rows of poles Fi.

In order to move independently between rows, agricultural vehicles are advantageously equipped with a battery. If the collector rods lose contact with the lines for any reason, this battery is able to power the vehicle autonomously to regain contact with the line or change row.

These power lines are bifilar lines, which normally have a voltage of between 350 V and 3000 V direct or alternating current, supplied by the plant, which traditionally produces current energy with compatible voltages. The solar and/or wind power generation plant shall be equipped with intelligent management systems in order to provide these power lines with a sufficiently stable electrical voltage for running or recharging agricultural vehicles.

The plant may also be advantageously equipped with energy storage systems, allowing energy to be supplied to the supply and/or recharging lines of agricultural vehicles or vehicles in an efficient manner, compensating for any drop in plant production, lack of production due to environmental conditions, or managing different consumption devices associated with the plant itself.

If the agricultural vehicle is equipped with suitably sized batteries, there may also be a situation in which the overhead lines are not arranged over the entire system, i.e. in all the bays of the system, but only on some of them in an alternating manner, so that the vehicle connects to the lines on one bay to recharge the batteries (while driving or standing still) and in the other bays uses the battery charge.

As an alternative or in addition to overhead lines, the power supply means may comprise power lines embedded in the ground at or adjacent to the row of poles of the plant structure.

As an alternative or in addition to overhead lines, the power supply means may comprise a number of recharging stations distributed over the land T, according to a given distance that allows the agricultural vehicle to recharge its batteries.

These charging stations will be advantageously fixed to the structure of the plant.

Agricultural vehicles can also be equipped with autonomous driving systems, i.e. without an operator, using a series of sensors and feedback and/or recognition devices attached to the structure of the plant and the vehicle itself.

1. Plant for the production of electrical energy comprising
a support structure formed by support poles (2) aligned along a first axis (X) fixed to the ground,
said structure being configured with a plurality of parallel rows (Fi) of such poles (2) with any orientation, causing the formation of a two-dimensional structure along said first axis (X) and a second axis (Y) differently oriented with respect to the first,
this structure being installed on agricultural land (T), and the distance between the support posts, along both the X and Y axes, is such as to allow the passage and processing of the land by agricultural vehicles or vehicles,
on said support structure and in particular on rows of poles being positioned devices for the generation of electricity,
characterized by the fact that the plant includes means for the power supply of such electric agricultural vehicles or vehicles that work the land (T) where the plant is installed that use part of the electricity produced by the plant itself.

2. Plant according to claim 1, wherein said power supply means recharge power supply batteries of the agricultural vehicle.

3. Plant according to claim 1, wherein said means comprise a plurality of suspended electric power lines (L) for powering said electric agricultural vehicles or means equipped with suitable rods or collection devices for the electricity provided by these lines.

4. Plant according to claim 1, wherein said electric lines (L) are arranged in the space between two rows of poles, substantially parallel to said rows.

5. Plant according to claim 1, in which said lines are kept in suspension by means of the support structure formed by support poles (2) and tie rods or profiles (3), and possibly integrated by suitable further supports.

6. Plant according to claim 1, in which transverse supports (6) are provided which support the supply lines (L) placed in a median position between two rows of poles (Fi).

7. Plant according to claim 1, in which the power supply means include electrical lines embedded in the ground in correspondence or adjacent to the row of poles of the plant structure.

8. Plant according to claim 1, wherein the power supply means comprise a plurality of recharging stations distributed on the ground (T), according to a determined distance which allows the agricultural vehicle to recharge its batteries.

9. Plant according to claim 8, in which said recharging stations are fixed to the plant structure.

10. Plant according to claim 1, in which systems for the movement or orientation of said photovoltaic panels are arranged on said support structure.

11. Plant according to claim 1, in which agricultural vehicles or vehicles are equipped with automated piloting systems, based on a series of sensors installed on said vehicles and on the plant infrastructure.

12. Plant according to claim 1, in which said devices for generating electrical energy are photovoltaic panels and/or wind devices.

13. Plant according to claim 1, in which said second axis (Y) is substantially orthogonal to the first (X) to form a “checkerboard” structure.

14. Plant according to claim 1, in which intelligent management systems allow supplying the power supply and/or recharging lines of agricultural vehicles or vehicles with a sufficiently stable electrical voltage for running or recharging them.

15. Plant according to claim 1, in which energy storage systems allow energy to be supplied to the supply lines and/or recharge of agricultural vehicles or vehicles in an efficient way, compensating for any production drops in the plant lack of production due to environmental conditions, or by managing various consumption devices associated with the system itself.
